(19) United States
(12) Patent Application Publication
(10) Pub. No.: US 2004/0193940 A1
(43) Pub. Date: Sep. 30, 2004

(54) WebDAV unit test framework

(76) Inventors: Joseph J. Snyder, Shamon, NJ (US); Jason Kinner, Marlton, NJ (US); Richard Friedman, Cherry Hill, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/372,530

(22) Filed: Feb. 21, 2003

(51) Int. Cl. H02H 3/05

(52) U.S. Cl. 714/4

(57) ABSTRACT

A method of unit testing of a component selected from the group consisting of applications and server implementations for response relative to the WebDAV protocol is provided. The method comprises providing a WebDAV unit testing framework and providing a WebDAV compliance utility containing a suite of unit tests. The method further comprises applying a unit test from the suite to the component under test via the unit-testing framework, and comparing the response of the component to the applied unit test with a standard unit test response stored in memory.

### CROSS-REFERENCE TO RELATED APPLICATIONS

This Application is related to co-pending, concurrently filed, and commonly assigned U.S. patent applications Ser. No. [Attorney Docket No. 100203190-1] entitled “XML DRIVEN WEBDAV UNIT TEST FRAMEWORK,” Serial Number [Attorney Docket No. 100202442-1] entitled “CONNECTING TO WEBDAV SERVERS VIA THE JAVATM CONNECTOR ARCHITECTURE,” and Serial Number [Attorney Docket No. 100202441-1] entitled “WEBDAV URL CONNECTION,” the disclosures of all of which are hereby incorporated herein by reference.

### BACKGROUND

Rich media is an Internet industry term for a Web page advertisement that uses advanced technology such as streaming video, downloaded applets (programs) that interact instantly with the user, and advertisements that change appearance and/or content when the user's cursor passes over them. The foundation of rich media architecture is the storage layer for digital assets, e.g., any digitally stored information. Providing an abstraction to the digital assets is the key to developing rich media-based applications and services. Defining this layer has the same importance as defining a common language and Application Programming Interfaces (APIs) for accessing traditional relational database systems. The storage layer comprises the asset, the metadata about the asset, and the structure to store this information. The storage layer has to provide expected features such as insert, update, delete and query.

Today, where and how to store digital assets, metadata, and the associations between them is a complex problem. Different applications can have vastly different requirements for storage. It is generally desirable to provide an abstract storage mechanism that will allow for heterogeneous storage for any or all of the above storage layer objects. Web-based Distributed Authoring and Versioning (WebDAV) is a protocol defined by the IETF RFC 2518 and is an extension of the HTTP protocol (RFC 2616). The WebDAV specification addresses the storage of all three types of object, and is currently in use in network storage solutions and web servers, as well as being supported in many authoring tools and in most operating systems.

Content management solutions, including editing functions such as read, write, delete, move, copy, etc., are a good fit for the storage requirements as well, and many already support WebDAV. In fact, WebDAV is divided into three separate specifications, each of which addresses particular storage operations: WebDAV (Web Distributed Authoring and Versioning), DASL (Searching and Locating), and Delta-V (Versioning). The WebDAV platform can also make it easier to add WebDAV capabilities to an existing Content Management System (CMS), in order to promote WebDAV technology.

### SUMMARY

In accordance with a first embodiment disclosed herein, a system operable to support Web-based Distributed Authoring and Versioning (WebDAV) protocol is provided. The system comprises a plurality of applications and server implementations. The system further comprises a WebDAV unit testing framework operable to facilitate unit testing of the applications and server implementations for compliance with WebDAV protocol, such that the WebDAV unit testing framework is operable to allow the servers to be tested for compliance with the WebDAV protocol via a simple Application Programming Interface (API).

In another embodiment disclosed herein, a method of unit testing of a component selected from the group consisting of applications and server implementations for response relative to the WebDAV protocol is provided. The method comprises providing a WebDAV unit testing framework and providing a WebDAV compliance utility containing a suite of unit tests. The method further comprises applying a unit test from the suite to the component under test via the unit-testing framework, and comparing the response of the component to the applied unit test with a standard unit test response stored in memory.

In another embodiment disclosed herein, a system operable to support Web-based Distributed Authoring and Versioning (WebDAV) protocol is provided. The system comprises means for providing a WebDAV unit testing framework and means for providing a WebDAV compliance utility containing a suite of unit tests. The system further comprises means for applying a unit test from the suite to the component under test via the unit-testing framework, and means for comparing the response of the component to the applied unit test with a standard unit test response stored in memory.

In another embodiment disclosed herein, computer-executable software code stored to a computer-readable medium is provided. The computer-executable software code comprises code for applying a unit test from a suite to a component under test via a unit-testing framework, and code for comparing the response of the component to the applied unit test with a standard unit test response stored in memory.

### BRIEF DESCRIPTION OF THE DRAWING

FIG. 1 is a block diagram illustrating an overview of WebDAV system architecture according to the present embodiments; and

FIG. 2 is a more detailed schematic block diagram illustrating the relationships between WebDAV Unit framework, HTTP Unit, WebDAV Compliance utility, and WebDAV server within the WebDAV system architecture.

### DETAILED DESCRIPTION

A system and method facilitate unit testing of components, for example applications and server implementations, for compliance with the WebDAV protocol using a WebDAV compliance utility to provide a performance suite of examples for testing via a simple API. A performance test from the suite is applied to the component under test via a WebDAV unit testing framework and the response of the component to the performance test is compared with a standard response stored in memory. The WebDAV unit testing framework allows automated unit testing of components and extends the open source HTTP unit testing framework, which allows similar unit testing of components for compliance with the HTTP protocol. In various embodiments, the WebDAV unit testing framework holds the context for a series of WebDAV requests, manages cookies used to maintain session context, computes relative URLs, and/or emulates client behavior needed to implement automated WebDAV compliance test of a component. In some embodiments, the WebDAV unit testing framework further holds the content of a WebDAV request, including for example WebDAV method, header information, and body of request.

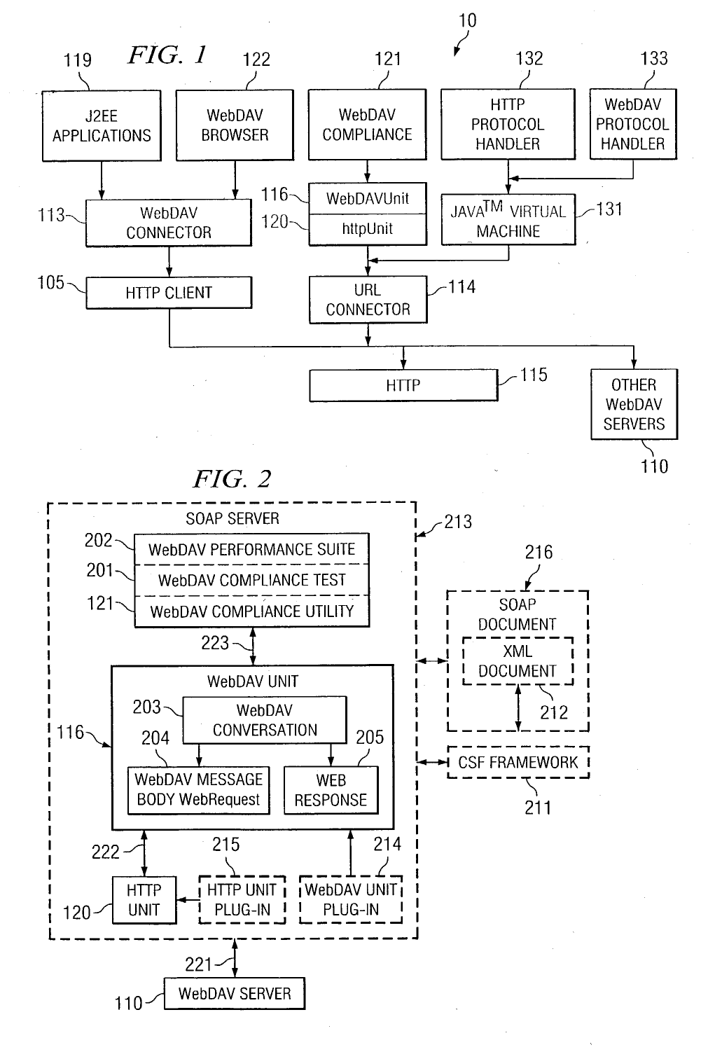

The storage abstraction architecture has produced many components which create both the abstraction for the storage system and a usable storage infrastructure upon which systems are created. While much of the storage abstraction is viewed as a server side layer, there are many layers of connectivity into such a layer. FIG. 1 is a partial overview block diagram illustrating various components of WebDAV system architecture 10, which includes mechanisms for connecting and testing such systems, according to the present embodiments.

WebDAV system architecture 10 comprises various components that are made available within an installation. Each component, whether for example a web application or a library, has its own description of usage and configuration.

Architecture 10 further includes WebDAV Java™ Connector Architecture (JCA) connector 113, which provides a standard client API for connecting into WebDAV server 110. JCA connector 113 utilizes HTTP client 105 for HTTP connectivity. HTTP client 105, which is outside the scope of the present disclosures, is adapted from the open source HTTP client efforts within the Apache Jakarta Commons project. The home page for Commons HTTP client is HTTP://jakarta.apache.org/commons/HTTPclient/. HTTP URL connector 114, which extends the common Java™ Development Kit (JDK) version, is provided to upgrade prior art HTTP URL connector 115, which does not presently support the needed WebDAV methods.

It is further advantageous in WebDAV architecture 10 to access any WebDAV server 110 and/or any non-relational data sources from a WebDAV browser, for example WebDAV browser 122, and/or from a J2EE application, for example J2EE application 119, via a WebDAV-compliant connector that conforms to Java™ Connector Architecture (JCA), depicted as WebDAV connector 113.

WebDAV Protocol Handler 133 is a low-level component that allows an application to have a raw WebDAV conversation with a WebDAV server, for example WebDAV server 110. According to some embodiments, JAVA™ Virtual Machine (JVM) 131 is configured to use WebDAV Protocol Handler 133 instead of traditional HTTP protocol handler 132 for HTTP requests by setting the system property java.protocol.handler.pkgs to com.hp.mw.richmedia.webdav.protocol. Any subsequent HTTP URL requests are then resolved using WebDAV Protocol Handler 133. After configuring WebDAV Protocol Handler 133 for use on HTTP connections, WebDAV Protocol Handler 133 utilizes the URL openConnection( ) mechanism for a subsequent HTTP URL request. When JAVA™ Virtual Machine (JVM) 131 is configured to use traditional HTTP protocol handler 132 for HTTP requests, however, HTTP URL requests are not WebDAV compliant.

WebDAV Unit 116 was built as an adaptation of traditional HTTP Unit 120 web testing framework. WebDAV Unit 116 aims to simplify the creation of WebDAV unit tests. WebDAV Unit 116 is a unit testing framework extending open source HTTP Unit framework 120, allowing unit testing of WebDAV application and server implementations employing WebDAV Compliance utility 121. In the context of the present disclosure, a unit test is a test of one application to see if remediation efforts were successful. The unit test does not generally test how well the tested application will work in an interaction with other applications. Thus, a unit test is an invocation that tests a definable and confined unit. For example, testing a WebDAV method is a unit test. Advantageously, WebDAV Unit 116 allows WebDAV servers 110 to be tested via a simple API and allows automated testing of WebDAV servers 110. A test suite is created to invoke test operations against a WebDAV server, simulating what real users might or might not do in an environment in which a user could invoke many links and directions.

FIG. 2 is a more detailed schematic block diagram illustrating the relationships between WebDAV Unit framework 116, HTTP Unit framework 120, WebDAV Compliance utility 121, and WebDAV server 110 through links 221, 222, and 223 within WebDAV system architecture 10 in accordance with one embodiment. Links 221, 222, and 223 can be although need not be physical links, and can be any sort of hardware or software communication links in a network. In accordance with the present embodiment, WebDAV Unit 116 comprises three main objects, namely WebDAVConversation 203, WebDAVMessageBodyWebRequest 204, and WebResponse 205. WebDAVConversation 203 holds the context for a series of WebDAV requests. It manages cookies used to maintain session context, computes relative URLs and generally emulates client behavior needed to build an automated test of a WebDAV server. WebDAVMessageBodyWebRequest 204 class is the base class for all WebDAV requests. It holds the contents of a request including the WebDAV method, header information, and the body of the request. WebResponse 205 class represents the response of a standard HTTP or WebDAV request. It contains response headers as well as response data.

In some embodiments, unit testing is run in a service oriented architecture, for example Core Services Framework (CSF) 211. CSF 211 is a services-based container in WebDAV architecture 10, which allows disparate services to interact with one another. Applications are built by deploying the services needed by the application. In some embodiments, WebDAV Unit 116 is implemented as a CSF service. Advantageously, this allows WebDAV Unit 116 to be controlled by CSF framework 211 and allows easy integration with applications that require it. Similarly, in some embodiments HTTP Unit framework 120 is implemented as a CSF service, such that HTTP Unit 120 is controlled advantageously by CSF framework 211, allowing easy integration with applications that require it.

WebDAV Compliance utility 121 built upon WebDAV Unit is the beginning of a test suite, for example WebDAV Compliance Suite 201 and/or WebDAV Performance Suite 202, which are each a set of WebDAV unit tests (a suite) that provide information about their respective topic. For example, a WebDAV Compliance Test is a unit test used to confirm if a WebDAV server, for example WebDAV server 110, is compliant with the WebDAV standard. WebDAV Compliance Suite 201 provides a complete set of tests that would validate if a WebDAV server as complying with the WebDAV specification (RFC2518). Similarly, a WebDAV Performance test is a unit test used to guarantee that a WebDAV server delivers a specific performance, for example a specific response time, in response to the specific unit test. A WebDAV Performance Test measures a product's efficiency or performance while it is running, and is thus more subjective than a WebDAV compliance test. WebDAV Performance Suite 202 comprises a group of tests that measure a product's performance in different WebDAV contexts.

In some embodiments, an eXtensible Markup Language (XML) document 212 can be used to drive and define the tests that are run by WebDAV Unit 116. Advantageously, by using XML to define the tests, no code needs to be written to add new tests or to modify existing tests, whereas traditional methods require the writing of code for each WebDAV Unit test that is performed. This greatly reduces the programming sophistication required of the person routinely writing or modifying the tests.

In some embodiments, WebDAV Compliance Test 201 and/or WebDAV Performance Suite 202 is implemented as a web service, advantageously allowing WebDAV Compliance Test 201 to be accessed and used like other web services. In some embodiments, WebDAV Performance Suite 202 is offered as a web service via Simple Object Access Protocol (SOAP), an existing technology that is used to access web services. Defining a SOAP envelope 213 for WebDAV Performance Suite 202 allows it to be accessed via SOAP.

To drive WebDAV Compliance Test 201 and WebDAV Performance Suite 202 unit tests as XML documents, thereby exposing WebDAV test suites 201, 202 (or WebDAV unit in general) as a web service, XML Document 212 is wrapped in a SOAP Envelope, for example SOAP Document 216. This is accomplished in accordance with conventional practice by embedding XML Document 212 in SOAP Document 216. Similarly, XML driven WebDAV Unit 116 is embedded in SOAP server 213 and connected via WebDAV Unit plug-in mechanism 214 provided by SOAP server 213. In some embodiments, SOAP server 213 alternatively or additionally wraps HTTP Unit 120, thereby allowing HTTP unit testing to be driven as a web service by XML document 212.

Advantageously, a) tests do not need to be compiled; b) a human readable format (XML) eliminates the need for prior knowledge of a programming language; c) tests can be created and/or modified rapidly; and d) as a web service, tests can be invoked simply through a browser or potentially via email.

What is claimed is:

1. A system operable to support Web-based Distributed Authoring and Versioning (WebDAV) protocol, said system comprising:
a plurality of applications and server implementations; and
a WebDAV unit testing framework operable to facilitate unit testing of said applications and said server implementations for compliance with WebDAV protocol;
wherein said WebDAV unit testing framework is operable to allow said servers to be tested for compliance with said WebDAV protocol via a simple Application Programming Interface (API).

2. The system of claim 1 further comprising a WebDAV compliance utility operable to provide a performance suite of unit tests for measuring performance of said applications and said server implementations during operation within a WebDAV protocol environment via said WebDAV unit testing framework.

3. The system of claim 1 wherein said WebDAV unit testing framework is operable to allow automated testing of said applications and said server implementations within a WebDAV protocol environment.

4. The system of claim 1 wherein said WebDAV unit testing framework further comprises a first object operable to contain the context for a series of WebDAV requests.

5. The system of claim 4 wherein said first object is operable to compute relative URLs.

6. The system of claim 4 wherein said first object is operable to emulate client behavior needed to perform an automated test of said server implementations in said WebDAV protocol environment.

7. The system of claim 1 wherein said WebDAV unit testing framework further comprises a first class operable to hold the contents of said WebDAV request;

8. The system of claim 7 wherein said contents are selected from the group consisting of WebDAV method, header information, and body of request.

9. The system of claim 1 wherein said WebDAV unit testing framework further comprises a second class operable to represent a response of a standard HTTP request and/or WebDAV request.

10. The system of claim 9 wherein said second class contains response headers and response data.

11. A method of unit testing of a component selected from the group consisting of applications and server implementations for response relative to the WebDAV protocol, said method comprising:
providing a WebDAV unit testing framework;
providing a WebDAV compliance utility containing a suite of unit tests;
applying a unit test from said suite to said component under test via said unit-testing framework; and
comparing the response of said component to said applied unit test with a standard unit test response stored in memory.

12. The method of claim 11 wherein said unit test is applied via a simple Application Programming Interface (API).

13. The method of claim 11 wherein said testing is automated.

14. The method of claim 11 further comprising storing the context for a series of WebDAV requests in said WebDAV unit testing framework.

15. The method of claim 11 further comprising storing and managing cookies used to maintain session context.

16. The method of claim 11 further comprising computing relative URLs.

17. The method of claim 11 wherein said WebDAV unit testing framework emulates client behavior needed to implement an automated WebDAV unit test of said component.

18. The method of claim 11 further comprising storing contents of a WebDAV request in said WebDAV unit testing framework.

19. The method of claim 11 further comprising storing data representing said standard unit test response in said WebDAV unit testing framework.

20. The method of claim 11 wherein said applied unit test measures a capability of said component selected from the group consisting of compliance of said component with said WebDAV protocol and specific performance of said component during operation within a WebDAV protocol environment.

21. A system operable to support Web-based Distributed Authoring and Versioning (WebDAV) protocol, said system comprising:
means for providing a WebDAV unit testing framework;
means for providing a WebDAV compliance utility containing a suite of unit tests;
means for applying a unit test from said suite to said component under test via said unit-testing framework; and
means for comparing the response of said component to said applied unit test with a standard unit test response stored in memory.

22. The system of claim 21 further comprising means for applying said unit test via a simple Application Programming Interface (API).

23. The system of claim 21 further comprising means for automating said testing.

24. The system of claim 21 further comprising means for storing the context for a series of WebDAV requests in said WebDAV unit testing framework.

25. The system of claim 21 further comprising means for storing and managing cookies used to maintain session context.

26. The system of claim 21 further comprising means for computing relative URLs.

27. The system of claim 21 wherein said WebDAV unit testing framework comprises means for emulating client behavior needed to implement an automated WebDAV unit test of said component.

28. The system of claim 21 further comprising means for storing contents of a WebDAV request in said WebDAV unit testing framework.

29. The system of claim 21 further comprising means for storing data representing said standard unit test response in said WebDAV unit testing framework.

30. The system of claim 21 further comprising means for said applied unit test to measure a capability of said component selected from the group consisting of compliance of said component with said WebDAV protocol and specific performance of said component during operation within a WebDAV protocol environment.

31. Computer-executable software code stored to a computer-readable medium, said computer-executable software code comprising:
code for applying a unit test from a suite to a component under test via a unit-testing framework; and
code for comparing the response of said component to said applied unit test with a standard unit test response stored in memory.

32. The computer-executable software code of claim 31 further comprising code for applying said unit test via a simple Application Programming Interface (API).

33. The computer-executable software code of claim 31 further comprising code for storing the context for a series of WebDAV requests in said WebDAV unit testing framework.

34. The computer-executable software code of claim 31 further comprising code for computing relative URLs.

35. The computer-executable software code of claim 31 further comprising code for emulating client behavior needed to implement an automated WebDAV unit test of said component.
